(19) United States
(12) Patent Application Publication
(10) Pub. No.: US 2026/0094222 A1
(43) Pub. Date: Apr. 2, 2026

(54) METHOD AND DEVICE FOR ADMINISTERING COMMUNICATION SKILLS ASSESSMENT AND GENERATING AUGMENTATIVE AND ALTERNATIVE COMMUNICATION STRATEGY, AND NON-TRANSITORY COMPUTER-READABLE MEDIUM

(71) Applicant: National Taiwan Normal University, Taipei City (TW)

(72) Inventors: Hui-Ting WANG, Taipei City (TW); Jia-Yin WANG, Taoyuan City (TW); Chun-Kai WANG, Taipei City (TW); Jia-Chi LIANG, Taoyuan City (TW); Ting-Xiang ZHUO, Taoyuan City (TW)

(21) Appl. No.: 19/262,706

(22) Filed: Jul. 8, 2025

(30) Foreign Application Priority Data
Sep. 30, 2024 (TW) 113137258

(51) Int. Cl. G06Q 50/20

(52) U.S. Cl. CPC G06Q 50/2057

(57) ABSTRACT

A method for administering a communication skills assessment and generating an augmentative and alternative communication (AAC) strategy is provided. The method is implemented by a computer device and includes steps of: displaying an input page for inputting of an activity, an activity location and an activity goal for a client; generating and displaying a key steps evaluation form that includes a plurality of key steps required for achieving the inputted goal, and a plurality of independence level entry fields that respectively correspond to the plurality of key steps, each of the plurality of independence level entry fields designed for inputting of information on communication independence level of the client corresponding to the respective one of the key steps; generating and displaying a plurality of communication needs; displaying a barriers evaluation questionnaire to be completed; and generating and displaying at least one communication strategy and a lesson plan.

### CROSS-REFERENCE TO RELATED APPLICATION

This application claims priority to Taiwanese Invention Patent Application No. 113137258, filed on Sep. 30, 2024, the entire disclosure of which is incorporated by reference herein.

### FIELD

The disclosure relates to a method and a device for administering a communication skills assessment and generating a communication strategy, and more particularly to a method and a device for administering a communication skills assessment and generating an augmentative and alternative communication (AAC) strategy that assess a client's communication problems and automatically generate a corresponding communication strategy and lesson plan.

### BACKGROUND

To assist clients with communication needs to participate in life and integrate into society, professionals need to assess communication problems of clients to provide situational teaching. However, when assessing communication skills, a multidisciplinary assessment team is usually required as assessments conducted by professionals from only a single discipline may not provide a complete picture. Moreover, the assessment involves complicated information, and the data collection process can be relatively difficult and time-consuming. This can result in a lack of comprehensiveness of an assessment, causing the formulated augmentative and alternative communication (AAC) strategy to fail to meet the needs of the client. Furthermore, lack of awareness of AAC and AAC needs, and high turnover rate of professionals, insufficient professional resources and training can also affect the effectiveness of the formulated strategy.

### SUMMARY

Therefore, an object of the disclosure is to provide a method and a device for administering a communication skills assessment and generating an augmentative and alternative communication (AAC) strategy that can alleviate at least one of the drawbacks of the prior art, and a non-transitory computer-readable recording medium.

According to an aspect of the disclosure, a method for administering a communication skills assessment and generating an AAC strategy is to be implemented by a computer device and includes steps of:
displaying an input page for inputting of an activity, an activity location and an activity goal for a client;
based on the activity, the activity location and the activity goal thus inputted, generating and displaying a key steps evaluation form, wherein the key steps evaluation form includes a plurality of key steps that are required for achieving the activity goal thus inputted, and a plurality of independence level entry fields that respectively correspond to the plurality of key steps, wherein each of the plurality of independence level entry fields is designed for inputting of information on communication independence level of the client corresponding to the respective one of the plurality of key steps;
based on the information on communication independence level thus inputted, generating and displaying a plurality of communication needs;
after receiving a plurality of confirmed communication needs relevant to the plurality of communication needs, displaying a barriers evaluation questionnaire to be completed; and
based on the information on communication independence level thus inputted, the plurality of confirmed communication needs, and a response to the barriers evaluation questionnaire, generating and displaying at least one communication strategy and a lesson plan corresponding to the at least one communication strategy.

According to another aspect of the disclosure, a device for administering a communication skills assessment and generating an AAC strategy includes a display unit, an input unit, and a processing unit electrically connected to the display unit and the input unit. The processing unit is configured to make the display unit display an input page for inputting of an activity, an activity location and an activity goal for a client via the input unit. Based on the activity, the activity location and the activity goal thus inputted, the processing unit is configured to generate and make the display unit display a key steps evaluation form, wherein the key steps evaluation form includes a plurality of key steps that are required for achieving the activity goal thus inputted, and a plurality of independence level entry fields that respectively correspond to the plurality of key steps. Each of the plurality of independence level entry fields is designed for inputting, via the input unit, of information on communication independence level of the client corresponding to the respective one of the plurality of key steps. Based on the information on communication independence level thus inputted, the processing unit is configured to generate and make the display unit display a plurality of communication needs. After receiving, via the input unit, a plurality of confirmed communication needs relevant to the plurality of communication needs, the processing unit is configured to make the display unit display a barriers evaluation questionnaire to be completed via the input unit. Then, based on the information on communication independence level thus inputted, the plurality of confirmed communication needs, and a response to the barriers evaluation questionnaire, the processing unit is configured to generate and make the display unit display at least one communication strategy and a lesson plan corresponding to the at least one communication strategy.

According to still another aspect of the disclosure, a non-transitory computer-readable recording medium stores a software program that, when installed and executed by a computer device, enables the computer device to implement the aforementioned method for administering a communication skills assessment and generating an AAC strategy.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating a method for administering a communication skills assessment and generating an augmentative and alternative communication (AAC) strategy according to an embodiment of the disclosure.

FIG. 2 is a block diagram illustrating a device for administering a communication skills assessment and generating an AAC strategy according to an embodiment of the disclosure.

FIG. 3 illustrates an input page for inputting of an activity, an activity location and an activity goal for a client according to an embodiment of the disclosure.

FIG. 4 illustrates a key steps evaluation form according to an embodiment of the disclosure.

FIG. 5 illustrates a communication needs page according to an embodiment of the disclosure.

FIG. 6 illustrates an assessment version selection page according to an embodiment of the disclosure.

FIG. 7 illustrates an assessment needs questionnaire according to an embodiment of the disclosure.

FIG. 8 illustrates a motor skills assessment page according to an embodiment of the disclosure.

FIG. 9 illustrates a cognitive/communication skills assessment page according to an embodiment of the disclosure.

FIG. 10 illustrates a communication symbols assessment page according to an embodiment of the disclosure.

FIG. 11 illustrates a preferred communication aid selection page according to an embodiment of the disclosure.

FIG. 12 illustrates an AAC strategy page according to an embodiment of the disclosure.

FIG. 13 illustrates an external barriers assessment page according to an embodiment of the disclosure.

FIG. 14 illustrates a resource list according to an embodiment of the disclosure.

FIG. 15 illustrates a progress tracking button displayed on a user instruction page according to an embodiment of the disclosure.

FIG. 16 illustrates a simplified evaluation form according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

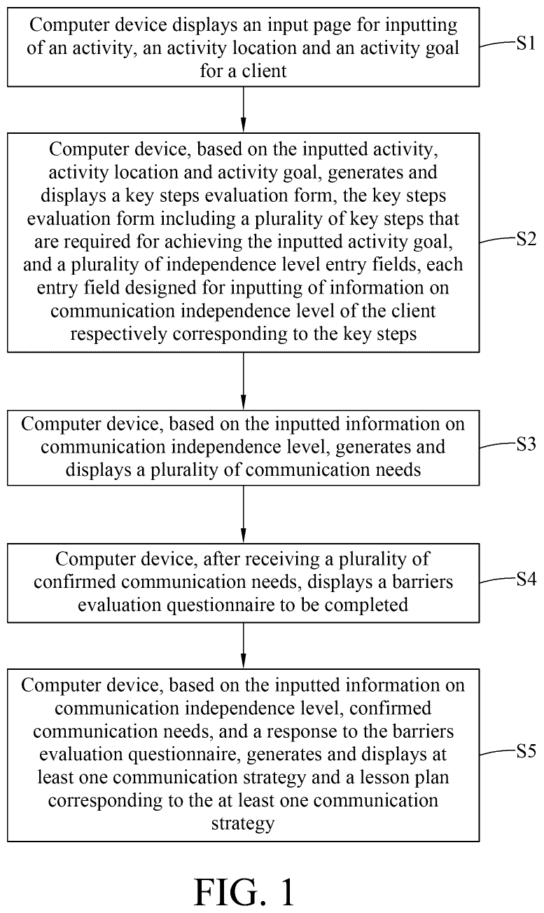

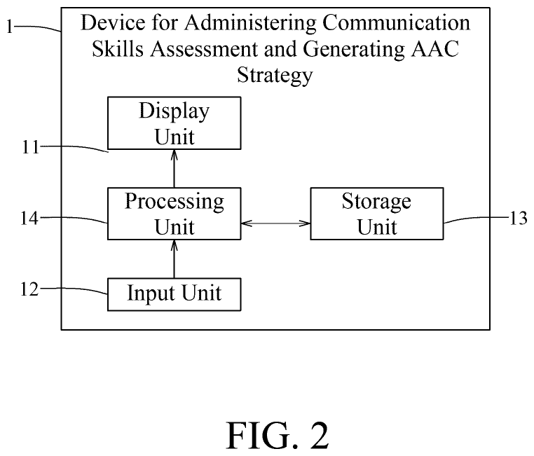

FIG. 1 is a flow chart that illustrates a method for administering a communication skills assessment and generating an augmentative and alternative communication (AAC) strategy according to an embodiment of the disclosure. The disclosure is based on an assessment process derived from evidence-based literatures on communication skills assessment and the generation of AAC. The method is to be implemented by a device for administering a communication skills assessment and generating an AAC strategy 1 (hereinafter device 1, see FIG. 2). The device 1 as shown in FIG. 2 is a computer device, for example, but not limited to, a personal computer, a laptop, a tablet, a smartphone, etc. The device 1 includes a display unit 11, an input unit 12, a storage unit 13, and a processing unit 14 electrically connected to the display unit 11, the input unit 12 and the storage unit 13.

The display unit 11 may be embodied using, for example, but not limited to, a flat panel display. The input unit 12 may be embodied using, for example, a physical keyboard and mouse, or a transparent touch panel disposed on the display unit 11 (flat panel display), which together with the display unit 11 forms a touch display, but the disclosure is not limited thereto. The storage unit 13 may be embodied using a memory device or memory module of any form. The processing unit 14 may be embodied using a processor that has computational capabilities, such as a central processing unit (CPU). The processing unit 14 is able to load and execute a software program stored on a non-transitory computer-readable recording medium (such as the storage unit 13), so as to implement the method illustrated in FIG. 1.

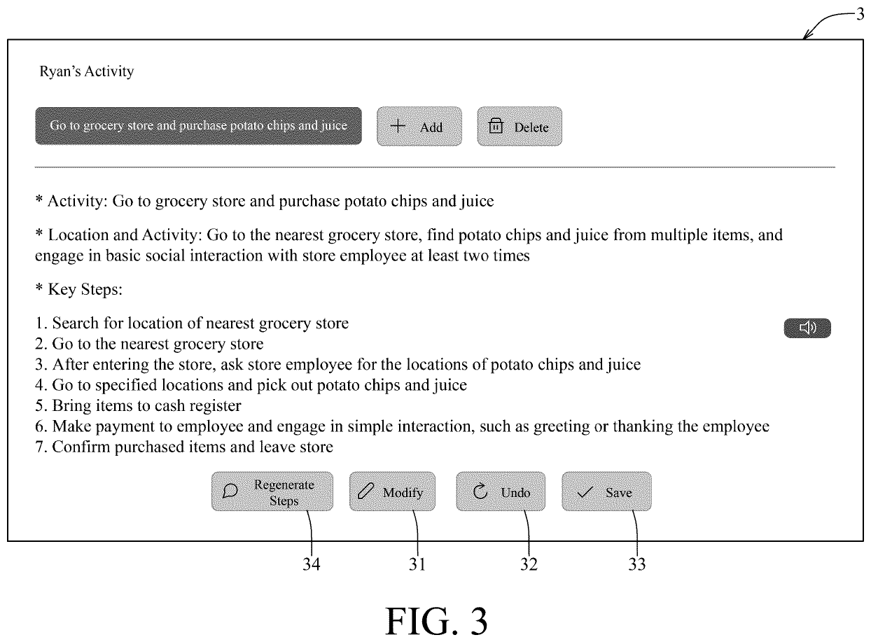

As shown in step S1 in FIG. 1, after the processing unit 14 executes the software program, the processing unit 14 makes the display unit 11 display an input page 3 (see FIG. 3) for inputting of an activity (e.g., go to grocery store and purchase potato chips and juice), an activity location and an activity goal (e.g., go to nearest grocery store, find potato chips and juice from among multiple items, and engage in basic social interaction with store employee at least two times) for a client (e.g., a client named Ryan) via the input unit 12.

Then, after a user (e.g., an AAC professional evaluator) confirms the activity, the activity location and the activity goal inputted on the input page 3 (e.g., by selecting a confirm button on the input page 3, not shown in drawings), the processing unit 14 utilizes an online generative artificial intelligence (AI) model (for example, but not limited to, GPT-4o) based on a first prompt and the inputted activity, activity location and activity goal to generate and display on the input page 3 a plurality of key steps that are required for achieving the inputted activity goal, such as the seven key steps displayed on the input page 3 in FIG. 3, for the user to confirm.

The first prompt prompts the generative AI model to generate and compose a paragraph based on three prompt structures (role setting, task description, output template), and the activity, the activity location and the activity goal inputted on the input page 3, wherein the prompt structures are as follows:
Role setting: AAC professional,
Task description: Generate key steps based on specified <activity and activity location>and <activity goal>,
Output template: 1. <Step 1> 2. <Step 2>3. <Step 3>. . .
   Based on the above information, the generative AI model generates the key steps as shown in FIG. 3.

In addition, the input page 3 in FIG. 3 includes a modify button 31, an undo button 32, a save button 33 and a regenerate steps button 34. When the user selects the modify button 31 via the input unit 12, the processing unit 14 allows the user to use the input unit 12 to modify the seven key steps displayed on the input page 3, so as to modify the content of the key steps or to add or delete key steps, etc. If the user selects the undo button 32, the processing unit 14 restores to an unmodified version the modified key steps. If the user selects the save button 33, the processing unit 14 saves to the storage unit 13 the key steps displayed on the input page 3. If the user selects the regenerate steps button 34, the processing unit 14 regenerates, based on the activity, the activity location and the activity goal inputted on the input page 3, a plurality of key steps that are required for achieving the inputted activity goal.

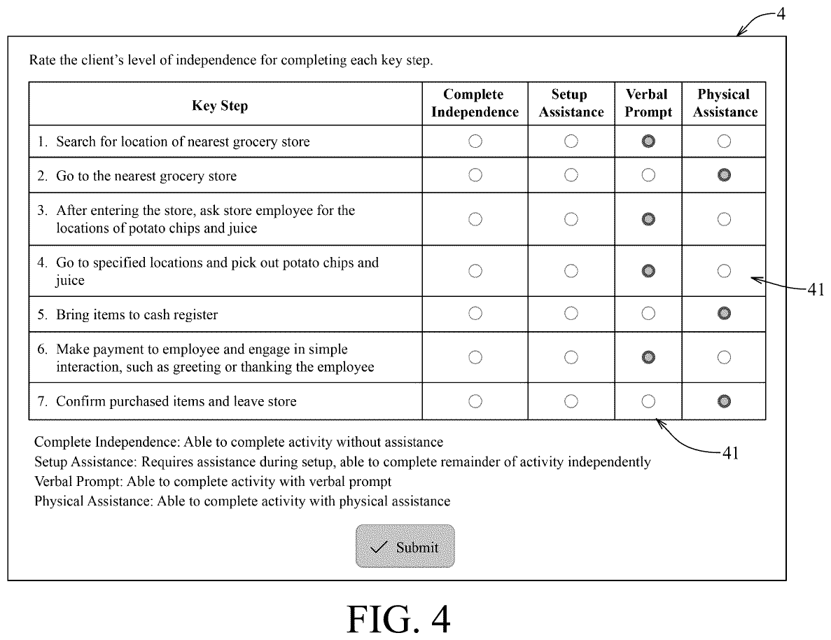

Then, after the user confirms the key steps displayed on the input page 3 (e.g., by selecting the save button 33), as shown in step S2 in FIG. 1, the processing unit 14 generates a key steps evaluation form 4, as shown in FIG. 4. The key steps evaluation form 4 includes a plurality of key steps (e.g., the seven key steps mentioned above) that are required for achieving the inputted activity goal, and a plurality of independence level entry fields 41 that respectively correspond to the plurality of key steps. Each of the independence level entry fields 41 is designed for the user to input, via the input unit 12, information on communication independence level of the client corresponding to the respective one of the key steps.

It is worth nothing that in other embodiments, the processing unit 14 can also directly generate, based on the activity, the activity location and the activity goal inputted on the input page 3, a key steps evaluation form that includes the key steps required for achieving the inputted activity goal.

In the embodiment of the disclosure, specifically, as shown in FIG. 4, each of the independence level entry fields 41 includes a complete independence option, a set up assistance option, a verbal prompt option and a physical assistance option for the user to select one option thereof via the input unit 12. When an option is selected for one of the key steps, the information on communication independence level that corresponds to the selected option is inputted into the independence level entry field 41 that corresponds to the one of the key steps. For example, when the verbal prompt option is selected for the key step “Search for location of nearest grocery store”, the information on communication independence level that corresponds to the verbal prompt option is inputted into the independence level entry field 41 that corresponds to the key step “Search for location of nearest grocery store”.

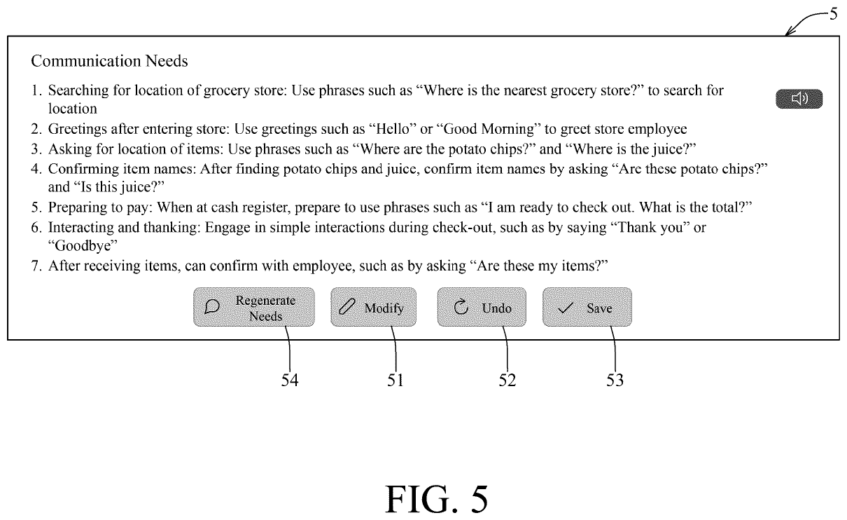

After the user inputs the information on communication independence level into the independence level entry fields 41 that respectively correspond to the key steps, and confirms the inputted information on communication level on the key steps evaluation form 4 (e.g., by selecting a submit button on the key steps evaluation form 4), as shown in step S3 in FIG. 1, the processing unit 14 utilizes an online generative AI model (for example, but not limited to, GPT-4o) based on a second prompt, a combination of the activity, the activity location and the activity goal inputted on the input page 3, and the information on communication independence level inputted on the key steps evaluation form 4 to generate and make the display unit 11 display a plurality of communication needs on a communication needs page 5 for the user to confirm (see FIG. 5). Each one of the key steps corresponds to a respective one of the communication needs.

Specifically, the second prompt prompts the generative AI model to generate and compose a paragraph based on three prompt structures (role setting, task description, output template), the combination of the activity, the activity location and the activity goal inputted on the input page 3, and the information on communication independence level inputted on the key steps evaluation form 4, wherein the prompt structures are as follows:
role setting: AAC professional,
Task description: Based on specified <activity and activity location>, <activity goal> and <key steps and communication independence levels>, provide communication needs that might be required to achieve activity goal,
Output template: 1. **<Communication Needs Preparation Item>**: <Communication Needs Usage Context and Content> 2. **<Communication Needs Preparation Item>**: <Communication Needs Preparation Item>3 . . .
   Based on the above information, the generative AI model generates the communication needs respectively corresponding to the key steps as shown in FIG. 5.

In addition, the communication needs page 5 includes a modify button 51, an undo button 52, a save button 53 and a regenerate needs button 54. The user can select the modify button 51 to modify, add or delete content of the communication needs, or select the undo button 52 to restore to an unmodified version the modified content of the communication needs. The user can select the regenerate needs button 54 to instruct the processing unit 14 to regenerate the communication needs respectively corresponding to the key steps. The user can also select the save button 53 to instruct the processing unit 14 to save to the storage unit 13 the key steps and the respective communication needs displayed on the communication needs page 5, and selecting the save button 53 indicates that the user confirms the communication needs displayed on the communication needs page 5.

After the user confirms the communication needs respectively corresponding to the key steps displayed on the communication needs page 5, as shown in step S4 in FIG. 1, the processing unit 14 makes the display unit 11 display a barriers evaluation questionnaire prepared in advance for the user to complete.

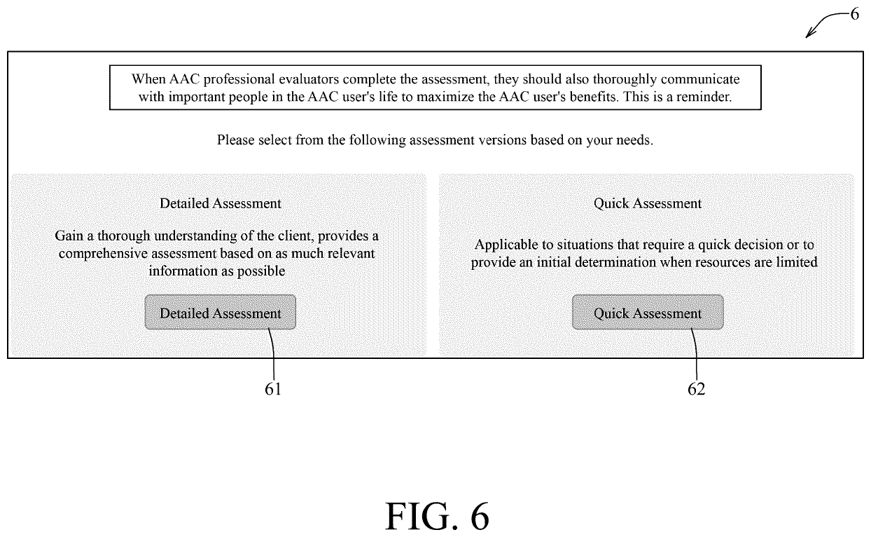

Specifically, in the embodiment of the disclosure, after the communication needs are confirmed, as shown in FIG. 6, the processing unit 14 will make the display unit 11 display an assessment version selection page 6 that includes a detailed assessment option 61 and a quick assessment option 62 for the user to select one thereof via the input unit 12. In one embodiment, in addition to the user inputting information, during a process of the communication skills assessment, a reminder message is also displayed to the user reminding the user to thoroughly communicate with other important people in the client's life to maximize benefits to the client.

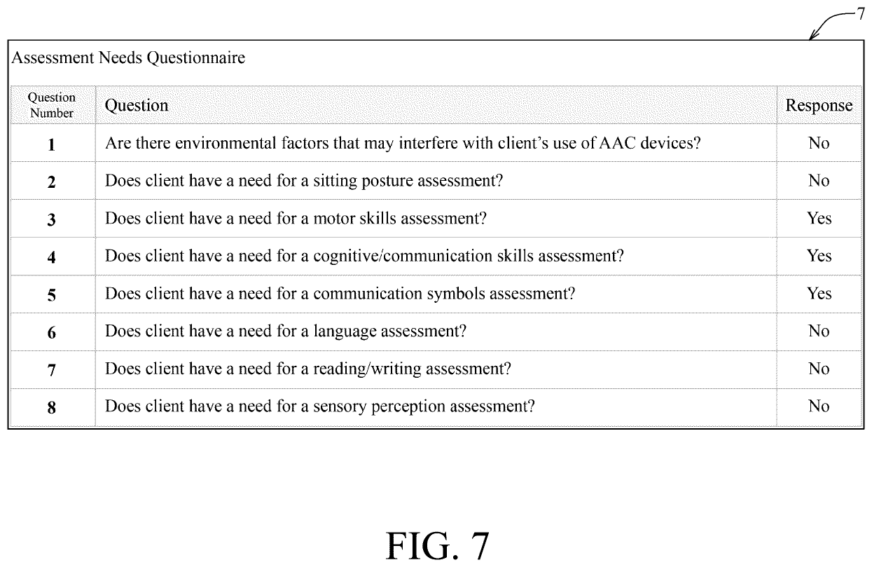

At this time, if the user selects the detailed assessment option 61, the processing unit 14 determines that the detailed assessment option 61 is selected and makes the barriers evaluation questionnaire include an assessment needs questionnaire 7 (see FIG. 7) and a detailed evaluation questionnaire, and makes the display unit 11 first display the assessment needs questionnaire 7 for the user to complete. This allows the user to respond with YES or NO to questions on the assessment needs questionnaire 7 to indicate whether the client has a need for assessments of certain abilities. For example, the questions in FIG. 7 with a response of YES indicate that the client has a need for a motor skills assessment, a need for a cognitive/communication skills assessment and a need for a communication symbols assessment.

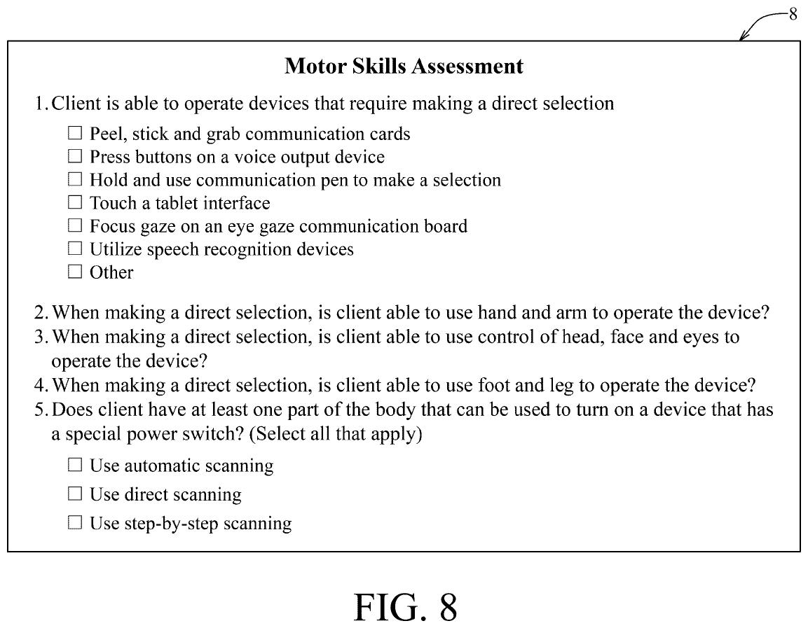

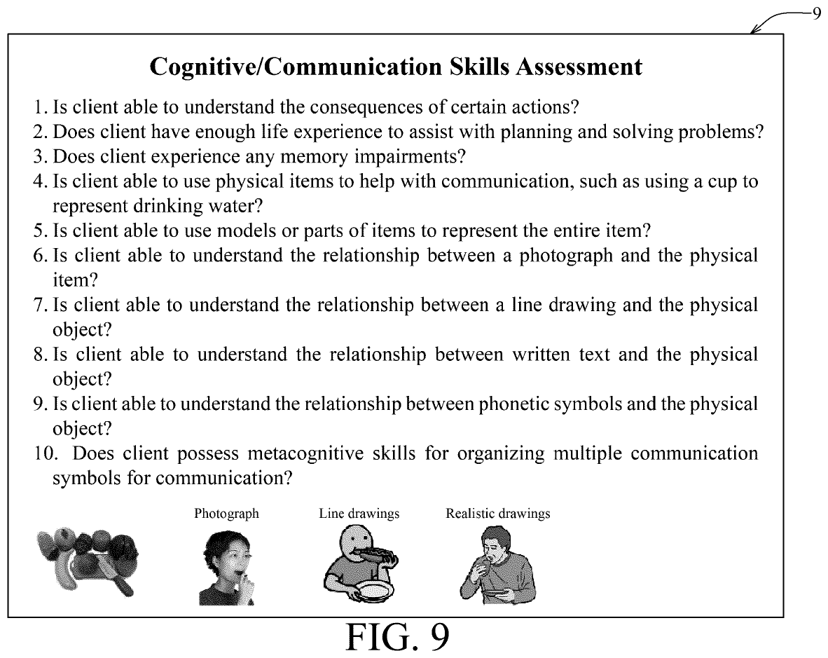

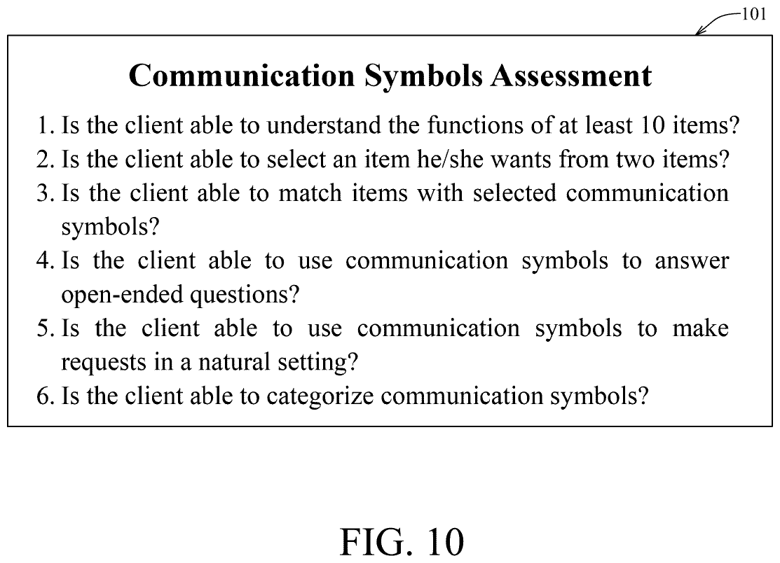

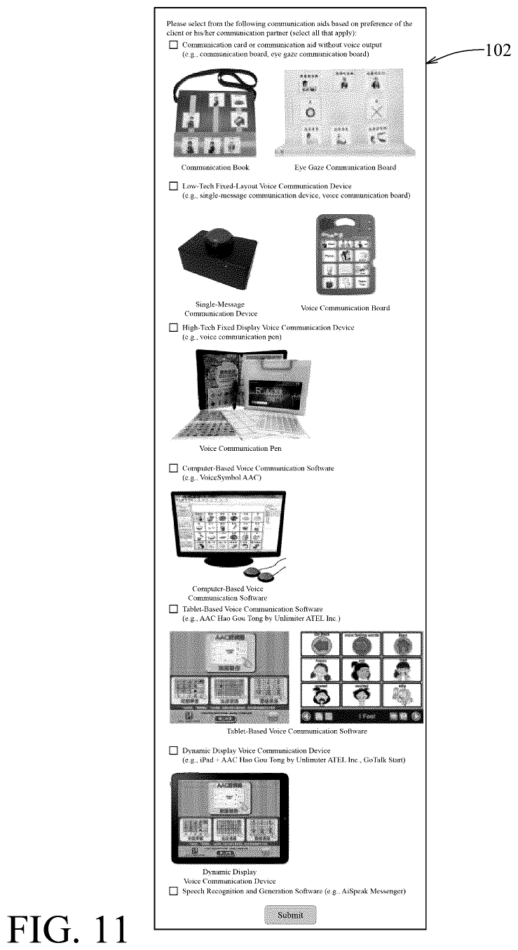

After the user completes the assessment needs questionnaire 7, the processing unit 14 determines questions to include on the detailed evaluation questionnaire based on a response to the assessment needs questionnaire, and makes the display unit 11 display the detailed evaluation questionnaire for the user to complete. For example, the detailed evaluation questionnaire may include questions related to a need for a motor skills assessment, a need for a cognitive/communication skills assessment and a need for a communication symbols assessment, along with a preferred communication aid selection section. FIG. 8 shows a motor skills assessment page 8 that includes an example of questions related to a need for a motor skills assessment. FIG. 9 shows a cognitive/communication skills assessment page 9 that includes an example of questions related to a need for a cognitive/communication skills assessment. FIG. 10 shows a communication symbols assessment page 101 that includes an example of questions related to a need for a communication symbols assessment. FIG. 11 shows an example of a preferred communication aid selection page 102, where the user can select communication aids that are suitable for the client.

If the user selects the quick assessment option 62 on the assessment version selection page 6, the processing unit 14 determines that the quick assessment option 62 is selected and makes the barriers evaluation questionnaire include all questions that are essential to a quick assessment producing a rapid determination. The questions that are essential come from, but are not limited to, the aforementioned questions related to a need for a motor skills assessment, questions related to a need for a cognitive/communication skills assessment, and the preferred communication aid selection section.

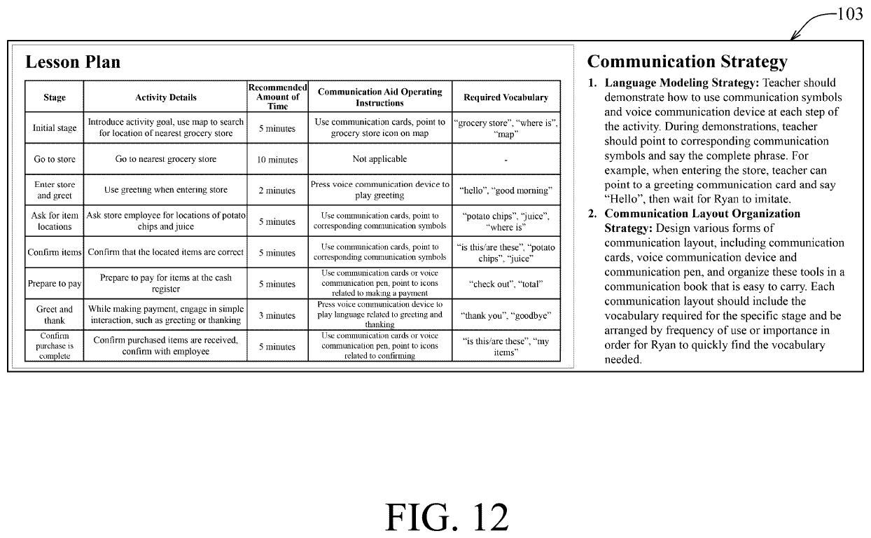

Then, when the user completes the barriers evaluation questionnaire and submits a response to the processing unit 14, as shown in step S5 in FIG. 1, the processing unit 14 utilizes an online generative AI model (for example, but not limited to, GPT-4o) based on a third prompt, the inputted information on communication independence level respectively corresponding to the key steps on the key steps evaluation form 4, the confirmed communication needs, and the response to the barriers evaluation questionnaire to generate at least one communication strategy and a lesson plan corresponding to the at least one communication strategy, and makes the display unit 11 display an AAC strategy page 103 that includes the at least one communication strategy and the lesson plan (see FIG. 12).

Specifically, the third prompt includes three prompt structures (role setting, task description, output template) wherein the prompt structures are as follows:
Role setting: AAC professional,
Task description: Using the AAC participation model as a framework, design activity lesson plan to serve as communication strategy based on key steps of the specified activity, client's communication independence level and client's communication needs,
Output template: List in a table format the step, activity details, recommended amount of time, communication aid operating instructions and required vocabulary for each stage.
   The third prompt prompts the generative AI model to generate a language modeling strategy and a communication layout organization strategy (see right side of FIG. 12) according to the above three prompt structures (role design, task description, output template) based on language modeling, communication layout organization, the inputted information on communication independence level respectively corresponding to the key steps on the key steps evaluation form 4, the confirmed communication needs and the response to the barriers evaluation questionnaire.

The third prompt also prompts the generative AI model to generate the lesson plan (see left side of FIG. 12) based on the third prompt, the language modeling strategy, the communication layout organization strategy and the inputted information on communication independence level respectively corresponding to the key steps on the key steps evaluation form 4, the confirmed communication needs, and the response to the barriers evaluation questionnaire. Content of the lesson plan includes activity details, recommended amount of time, communication aid operating instructions and vocabulary, etc., required for completing each stage of the activity.

It is worth noting that before the processing unit 14 generates the at least one communication strategy and the lesson plan, the processing unit 14 can also first generate and make the display unit 11 display a summary report based on the response to the barriers evaluation questionnaire, wherein the summary report includes communication symbols, communication aids and communication skills, etc., that are applicable to the client.

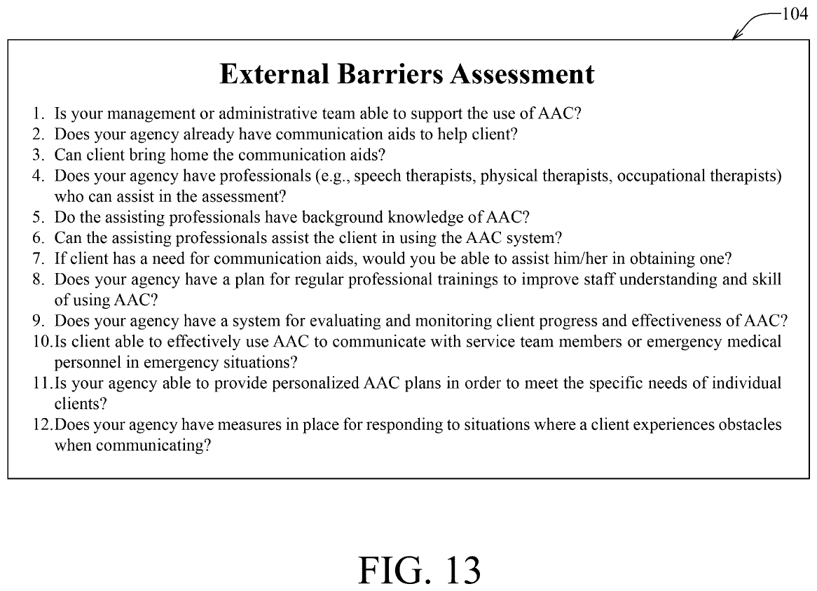

In addition, in the aforementioned step S4, when the processing unit 14 determines that a reply to a question related to external barriers on the assessment needs questionnaire 7 is affirmative (YES), the processing unit 14 will make the detailed evaluation questionnaire further include evaluation questions related to external barriers for the user to complete in order to identify external barriers currently experienced by the client (e.g., unfriendly environment, lack of appropriate communication aids, assisting professionals lacking AAC knowledge, skills or attitude, etc.). An example of the evaluation questions related to external barriers is shown on an external barriers assessment page 104 in FIG. 13. The term “AAC” as used on the external barriers assessment page 104 refers to communication aids that supplement or replace natural speech.

Furthermore, the processing unit 14 uses an online generative AI model (for example, but not limited to, GPT-4o) based on a fourth prompt and a response to the evaluation questions related to external barriers on the detailed evaluation questionnaire to generate and make the display unit 11 display a plan for overcoming external barriers, wherein the plan includes external barriers currently experienced by the client, and strategies for overcoming the external barriers. The plan may be referenced by supporting or instructing personnel (e.g., special education personnel) to assist the client in eliminating barriers in the environment imposed on the client, thereby increasing the client's participation in the activity.

Specifically, the fourth prompt includes three prompt structures (role setting, task description, output template) wherein the prompt structures are as follows:
Role setting: AAC professional,
Task description: Provide a plan to overcome each of the barriers in the environment imposed on the client,
Output template: 1. xxxxx 2. xxxxx 3. xxxxx...
   The fourth prompt prompts the generative AI model to generate the plan for overcoming external barriers according to the above three prompt structures (role design, task description, output template) based on the response to the evaluation questions related to external barriers included on the detailed evaluation questionnaire (e.g., questions in FIG. 13 with a response of NO).

For example, for external barriers “client is unable to bring home communication aids for use, “I am unable to assist client in obtaining a communication aid if client has a need for communication aids”, “client is unable to effectively use AAC to communicate with service team members or emergency medical personnel in emergency situations”, etc., the plan for overcoming external barriers may be:
1. Communicate with relevant organizations: Coordinate with relevant organizations (e.g., hospitals, social work agencies) to assist client in obtaining required communication aids, and understand the special needs of the client in emergency situations;
2. Provide training: Provide to the client and the client's family members or caretakers training related to communication aids so that they are able to effectively use the communication aids and communicate effectively with service team members or medical personnel in emergency situations; and
3. Establish response plan: Discuss and establish with the client a response plan to insure effective communication in emergency situations. This includes preparing in advance emergency contact information and method of contact to insure quick and effective communication when needed.

It is worth nothing that in the embodiment above, for privacy protection, when the information provided to the generative AI model contains the client name, the processing unit 14, through a conversion software program, first converts the client name in the provided information into a default placeholder name (e.g., John Doe), then, through the conversion software program, converts the default placeholder name (e.g., John Doe) shown in the information generated and outputted by the generative AI model back to the client name.

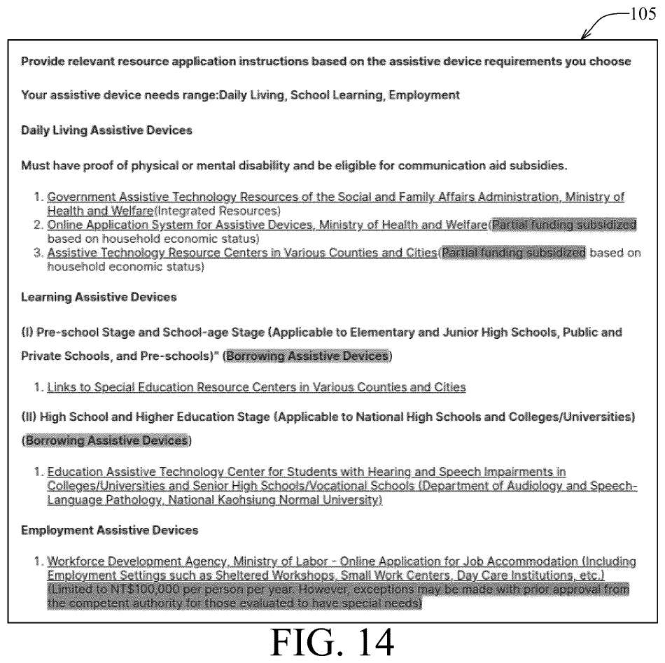

In one embodiment, the processing unit 14 makes the display unit 11 further display a resource list 105 (see FIG. 14) that reminds the user about relevant resources available and provides links to major domestic AAC equipment subsidy sources (e.g., education, social affairs, and employment services).

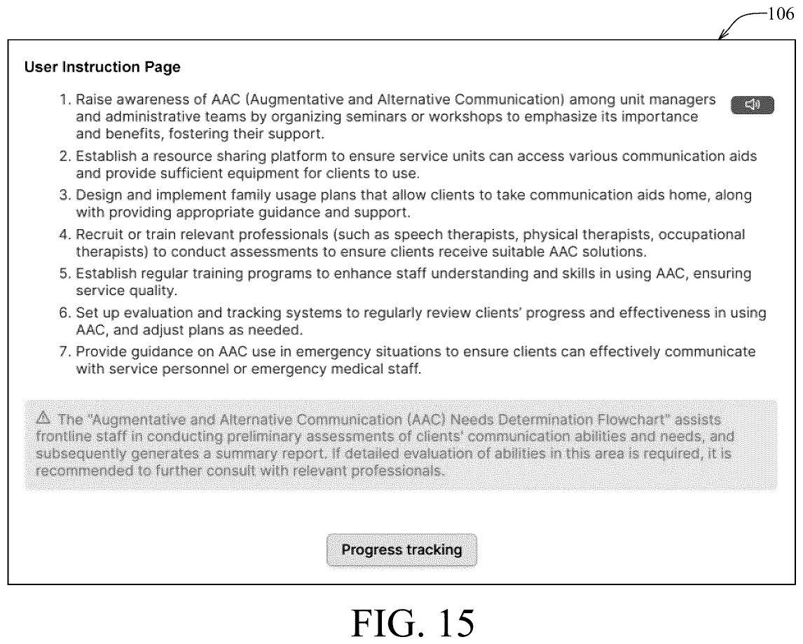

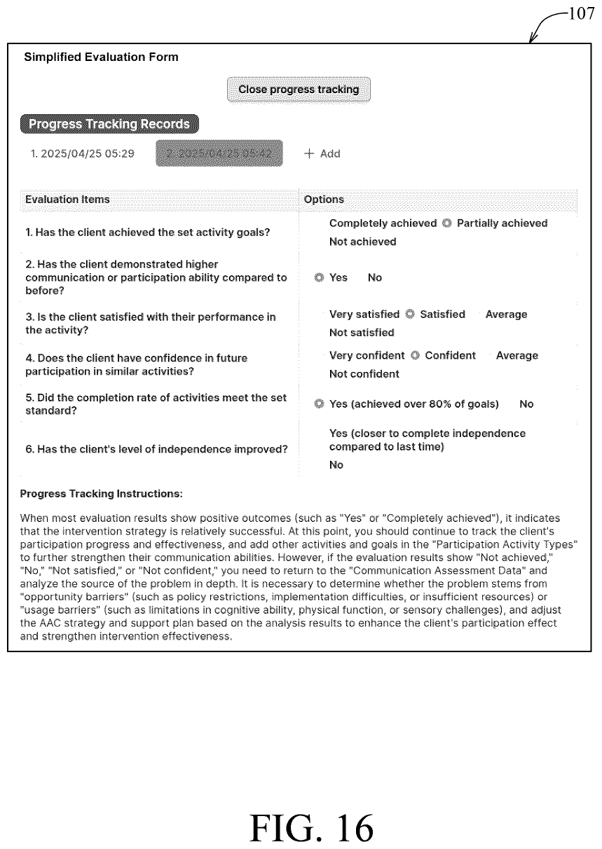

In one embodiment, the processing unit 14 makes the display unit 11 further display at the end of the communication skills assessment a progress tracking button on a user instruction page 106 (see FIG. 15) for the user to select to track progress and changes in the needs of the client using a simplified evaluation form 107 (see FIG. 16). The simplified evaluation form 107 provides a short set of questions related to the client's progress for the user to answer. Each time the simplified evaluation form 107 is completed by the user, the processing unit 14 saves the completed simplified evaluation form 107 to the storage unit 13.

In summary, the aforementioned embodiment integrates interdisciplinary empirical theories and practical experiences in the design of a user interface for a user to easily and quickly input an activity, an activity location and an activity goal for a client. Then, using a generative AI model based on a first prompt and the activity, the activity location and the activity goal inputted, a key steps evaluation form is generated for the user to input information on communication independence level respectively corresponding to a plurality of key steps of the activity. Next, using a generative AI model based on a second prompt and the inputted information on communication independence level, a plurality of communication needs are generated for the user to confirm. After the user confirms the communication needs, a barriers evaluation questionnaire is provided for the user to complete, and then a generative AI model based on a third prompt, the inputted information on communication independence level, confirmed communication needs, and a response to the barriers evaluation questionnaire is utilized to generate an effective communication strategy and a lesson plan corresponding to the communication strategy for the user to reference and use in assisting with the client's communication in order to help the client achieve the aforementioned activity goal.

In this way, in addition to assisting the user (a professional) in collecting information more easily to assess the client's communication barriers, based on the activity goal and the assessment results, a corresponding strategy is automatically generated and a lesson plan that meets the needs of the client is formulated for the user to reference. This addresses the current problems of lack of awareness of AAC and AAC needs, insufficient professional resources, high turnover rate of professionals, and poor professional training, and increases the efficiency of the generation of lesson plans, thereby achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for administering a communication skills assessment and generating an augmentative and alternative communication (AAC) strategy, the method being implemented by a computer device and comprising steps of:
displaying an input page for inputting of an activity, an activity location and an activity goal for a client;
based on the activity, the activity location and the activity goal thus inputted, generating and displaying a key steps evaluation form, the key steps evaluation form including a plurality of key steps that are required for achieving the activity goal thus inputted, and a plurality of independence level entry fields that respectively correspond to the plurality of key steps, each of the plurality of independence level entry fields designed for inputting of information on communication independence level of the client corresponding to the respective one of the plurality of key steps;
based on the information on communication independence level thus inputted, generating and displaying a plurality of communication needs;
after receiving a plurality of confirmed communication needs relevant to the plurality of communication needs, displaying a barriers evaluation questionnaire to be completed; and
based on the information on communication independence level thus inputted, the plurality of confirmed communication needs, and a response to the barriers evaluation questionnaire, generating and displaying at least one communication strategy and a lesson plan corresponding to the at least one communication strategy.

2. The method as claimed in claim 1, wherein the step of generating the key steps evaluation form includes:
based on the activity, the activity location and the activity goal thus inputted on the input page, generating and displaying a plurality of key steps; and
based on a plurality of confirmed key steps relevant to the plurality of key steps, generating the key steps evaluation form.

3. The method as claimed in claim 2, wherein:
the computer device utilizes a generative artificial intelligence (AI) model based on a first prompt and the activity, the activity location and the activity goal thus inputted on the input page to generate the plurality of key steps;
the computer device utilizes a generative AI model based on a second prompt, a combination of the activity, the activity location and the activity goal thus inputted on the input page, and the information on communication independence level thus inputted on the key steps evaluation form to generate the plurality of communication needs;
the computer device utilizes a generative AI model based on a third prompt, the information on communication independence level thus inputted, the plurality of confirmed communication needs, and the response to the barriers evaluation questionnaire to generate the at least one communication strategy and the lesson plan corresponding to the at least one communication strategy; and
the at least one communication strategy includes a language modeling strategy and a communication layout organization strategy that are generated based on language modeling and communication layout organization.

4. The method as claimed in claim 1, wherein each of the plurality of independence level entry fields on the key steps evaluation form includes a complete independence option, a setup assistance option, a verbal prompt option and a physical prompt option for selection of one thereof.

5. The method as claimed in claim 1, further comprising steps of, after receiving the plurality of confirmed communication needs:
displaying a detailed assessment option and a quick assessment option for selection;
in response to determining that the detailed assessment option is selected, generating the barriers evaluation questionnaire to include an assessment needs questionnaire and a detailed evaluation questionnaire to be completed, wherein questions on the detailed evaluation questionnaire are determined based on a response to the assessment needs questionnaire; and
in response to determining that the quick assessment option is selected, generating the barriers evaluation questionnaire to include all questions that are essential to a quick assessment producing a rapid determination.

6. The method as claimed in claim 5, wherein the step of generating the barriers evaluation questionnaire to include an assessment needs questionnaire and a detailed evaluation questionnaire includes, in response to determining that a reply to a question related to external barriers on the assessment needs questionnaire is affirmative:
generating the detailed evaluation questionnaire to further include evaluation questions related to external barriers; and
the method further comprises a step of:
based on a response to the evaluation questions related to external barriers included on the detailed evaluation questionnaire, generating and displaying a plan for overcoming external barriers, wherein the plan includes external barriers currently experienced by the client, and strategies for overcoming the external barriers.

7. The method as claimed in claim 6, wherein the computer device utilizes a generative AI model based on a fourth prompt and the response to the evaluation questions related to external barriers included in the detailed evaluation questionnaire to generate the plan for overcoming external barriers.

8. The method as claimed in claim 1, wherein the barriers evaluation questionnaire further includes a preferred communication aid selection section;
the method further comprising a step of, prior to generating the at least one communication strategy and the lesson plan corresponding to the at least one communication strategy:
based on the response to the barriers evaluation questionnaire, generating and displaying a summary report, wherein the summary report includes communication symbols, communication aids and communication skills that are applicable to the client.

9. A device for administering a communication skills assessment and generating an augmentative and alternative communication (AAC) strategy, comprising:
a display unit;
an input unit;
a processing unit electrically connected to said display unit and said input unit, wherein said processing unit is configured to:
make said display unit display an input page for inputting of an activity, an activity location and an activity goal for a client via said input unit;
based on the activity, the activity location and the activity goal thus inputted, generate and make said display unit display a key steps evaluation form, wherein the key steps evaluation form includes a plurality of key steps that are required for achieving the activity goal thus inputted, and a plurality of independence level entry fields that respectively correspond to the plurality of key steps, wherein each of the plurality of independence level entry fields is designed for inputting, via said input unit, of information on communication independence level of the client corresponding to the respective one of the plurality of key steps;
based on the information on communication independence level thus inputted, generate and make said display unit display a plurality of communication needs;
after receiving, via said input unit, a plurality of confirmed communication needs relevant to the plurality of communication needs, make said display unit display a barriers evaluation questionnaire to be completed via said input unit; and
based on the information on communication independence level thus inputted, the plurality of confirmed communication needs, and a response to the barriers evaluation questionnaire, generate and make said display unit display at least one communication strategy and a lesson plan corresponding to the at least one communication strategy.

10. The device as claimed in claim 9, wherein, to generate the key steps evaluation form, said processing unit is configured to:
based on the activity, the activity location and the activity goal thus inputted on the input page, generate and make said display unit display a plurality of key steps; and
based on a plurality of confirmed key steps relevant to the plurality of key steps, generate the key steps evaluation form.

11. The device as claimed in claim 10, wherein:
said processing unit is configured to utilize a generative artificial intelligence (AI) model based on a first prompt and the activity, the activity location and the activity goal thus inputted on the input page to generate the plurality of key steps;
said processing unit is configured to utilize a generative AI model based on a second prompt, a combination of the activity, the activity location and the activity goal thus inputted on the input page, and the information on communication independence level thus inputted on the key steps evaluation form to generate the plurality of communication needs;
said processing unit is configured to utilize a generative AI model based on a third prompt, the information on communication independence level thus inputted, the plurality of confirmed communication needs, and the response to the barriers evaluation questionnaire to generate the at least one communication strategy and the lesson plan corresponding to the at least one communication strategy; and
the at least one communication strategy includes a language modeling strategy and a communication layout organization strategy that are generated based on language modeling and communication layout organization.

12. The device as claimed in claim 9, wherein each of the plurality of independence level entry fields on the key steps evaluation form includes a complete independence option, a setup assistance option, a verbal prompt option and a physical prompt option for selection of one thereof.

13. The device as claimed in claim 9, wherein, after receiving the plurality of confirmed communication needs, said processing unit is configured to:
make said display unit display a detailed assessment option and a quick assessment option for selection;
in response to determining that the detailed assessment option is selected, generate the barriers evaluation questionnaire to include an assessment needs questionnaire and a detailed evaluation questionnaire to be completed, wherein questions on the detailed evaluation questionnaire are determined based on a response to the assessment needs questionnaire; and
in response to determining that the quick assessment option is selected, generate the barriers evaluation questionnaire to include all questions that are essential to a quick assessment producing a rapid determination.

14. The device as claimed in claim 13, wherein said processing unit is configured to:
in response to determining that a reply to a question related to external barriers on the assessment needs questionnaire is affirmative, generate the detailed evaluation questionnaire to further include evaluation questions related to external barriers; and
based on a response to the evaluation questions related to external barriers included on the detailed evaluation questionnaire, generate and make said display unit display a plan for overcoming external barriers, wherein the plan includes external barriers currently experienced by the client, and strategies for overcoming the external barriers.

15. The device as claimed in claim 14, wherein said processing unit is configured to utilize a generative AI model based on a fourth prompt and the response to the evaluation questions related to external barriers included in the detailed evaluation questionnaire to generate the plan for overcoming external barriers.

16. The device as claimed in claim 9, wherein:
the barriers evaluation questionnaire further includes a preferred communication aid selection section; and
said processing unit is configured to, prior to generating the at least one communication strategy and the lesson plan corresponding to the at least one communication strategy, based on the response to the barriers evaluation questionnaire, generate and make said display unit display a summary report, wherein the summary report includes communication symbols, communication aids and communication skills that are applicable to the client.

17. A non-transitory computer-readable recording medium storing a software program that, when installed and executed by a computer device, enables the computer device to implement the method as claimed in claim 1.
